(19) United States
(12) Patent Application Publication
(10) Pub. No.: US 2025/0383800 A1
(43) Pub. Date: Dec. 18, 2025

(54) CONFIGURABLE LOGICAL-TO-PHYSICAL TABLE STORAGE EXTENSION AT A MEMORY SYSTEM

(71) Applicant: Micron Technology, Inc., Boise, ID (US)

(72) Inventors: Jianxiong Huang, Shanghai (CN); Xiaolai Zhu, Shanghai (CN); Xiao Wang, Shanghai (CN)

(21) Appl. No.: 19/233,736

(22) Filed: Jun. 10, 2025

Related U.S. Application Data
(60) Provisional application No. 63/659,749, filed on Jun. 13, 2024.

(51) Int. Cl. G06F 3/06

(52) U.S. Cl. CPC G06F 3/0631; G06F 3/0604; G06F 3/0634; G06F 3/0659; G06F 3/0679

(57) ABSTRACT

Methods, systems, and devices for configurable logical-to-physical table storage extension at a memory system are described. The described techniques provide for a memory system to share host write data and logical-to-physical (L2P) extension data within a write buffer. If the memory system triggers L2P extension, the memory system may compare a quantity of available buffer units with an upper bound of a range of buffer units configured for L2P extension. For example, if enough buffer units are available for a full L2P extension, the memory system may allocate a full L2P extension, and if there are not enough buffer units available, the memory system may allocate a partial L2P extension. If the memory system allocates a partial L2P extension, the memory system may begin flushing write data stored to the buffer and may allocate newly available buffer units for the L2P extension.

### CROSS REFERENCE

The present Application for patent claims priority to U.S. Patent Application No. 63/659,749 by Huang et al., entitled “CONFIGURABLE LOGICAL-TO-PHYSICAL TABLE STORAGE EXTENSION AT A MEMORY SYSTEM,” filed Jun. 13, 2024, which is assigned to the assignee hereof, and which is expressly incorporated by reference in its entirety herein.

### TECHNICAL FIELD

The following relates to one or more systems for memory, including configurable logical-to-physical (L2P) table storage extension at a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports configurable logical-to-physical (L2P) table storage extension at a memory system in accordance with examples as disclosed herein.

FIG. 2 shows an example of a buffer allocation scheme that supports configurable L2P table storage extension at a memory system in accordance with examples as disclosed herein.

FIG. 3 shows an example of a process that supports configurable L2P table storage extension at a memory system in accordance with examples as disclosed herein.

FIG. 4 shows an example of a process that supports configurable L2P table storage extension at a memory system in accordance with examples as disclosed herein.

FIG. 5 shows a block diagram of a memory system that supports configurable L2P table storage extension at a memory system in accordance with examples as disclosed herein.

FIG. 6 shows a flowchart illustrating a method or methods that support configurable L2P table storage extension at a memory system in accordance with examples as disclosed herein.

### DETAILED DESCRIPTION

Memory systems may be configured to store and retrieve data in response to receiving commands (e.g., from a host system). For example, a memory system may receive a read command requesting that the memory system retrieve data stored to one or more memory arrays of the memory system. In some cases, as part of executing the read command, the memory system may load a logical-to-physical (L2P) table associated with a region to which the data is stored (e.g., a region of non-volatile memory). The L2P table may map relationships between logical addresses (e.g., indicated by commands received from the host system) and physical addresses of the region (e.g., locations within the region of the memory array), and the memory system may load the L2P table to support accessing the data. In some examples, the memory system may store the L2P table to volatile memory while executing the read command to support accessing the L2P table relatively quickly. The memory system may receive multiple read requests, which may result in the memory system loading multiple L2P tables. For example, if the memory system receives multiple random read requests, there may be a high likelihood that random read data indicated by different requests are associated with different regions of the memory system, and the memory system may load an L2P table for each region associated with the random read data.

In some examples, if a portion of volatile memory allocated for storing loaded L2P tables is full, the memory system may allocate a portion of a write buffer for storing L2P tables. Such schemes may be referred to as L2P extension, and the memory system may trigger the L2P extension when the portion of volatile memory allocated for storing L2P tables is full and the memory system receives a random read request indicating data stored to a region that is associated with an L2P table not present in the volatile memory (e.g., not yet loaded). The memory system may prioritize storing write data in the write buffer and may remove L2P table data from the write buffer if the memory system receives one or more write requests (e.g., flushing L2P data to make room for write data). However, such write requests may include relatively small amounts of data (e.g., small chunk write requests), and removing the L2P table data may result in relatively large portions of the buffer remaining empty after storing the write data (e.g., which may otherwise continue to store L2P table data). Additionally, removing the L2P table data may incur significant latency at the memory system due to the memory system retrieving the L2P table data again after executing the write commands.

In some cases, a memory system may support sharing of host write data and L2P extension data within a write buffer. The memory system may configure a range (e.g., a maximum and a minimum) of amounts of L2P extension data that can be stored to the write buffer when L2P extension is enabled. These quantities may be defined in terms of buffer units, which may represent a fixed quantity of storage space within the buffer. If the memory system triggers L2P extension, the memory system may compare a quantity of available buffer units (e.g., buffer units not currently storing data) with an upper bound of the range of buffer units configured for L2P extension. For example, if enough buffer units are available for a full L2P extension, the memory system may allocate the upper bound quantity of buffer units within the write buffer for L2P extension. Alternatively, if there are not enough buffer units available for full L2P extension, the memory system may allocate the currently-available buffer units for L2P extension (e.g., a partial L2P extension). If the memory system allocates a partial L2P extension, the memory system may begin flushing write data stored to the buffer and may allocate newly available buffer units for the L2P extension (e.g., until a full L2P extension is achieved). In some examples, the memory system may dedicate a portion of the write buffer for storing write data, such that small chunk write requests can be serviced while L2P extension is enabled. If the memory system receives a write request including data that has a size greater than the portion dedicated for write data, the memory system may exit the L2P extension and remove L2P data from the buffer. Such techniques may improve memory system performance when receiving relatively large amounts of random read data, which may reduce latency associated with retrieving the random read data.

In addition to applicability in memory systems as described herein, techniques for configurable L2P storage extension may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, techniques for configurable L2P storage extension may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by improving memory access speeds at edge computing devices and improving response times associated with edge computing devices, among other benefits.

Features of the disclosure are illustrated and described in the context of systems, devices, and circuits. Features of the disclosure are further illustrated and described in the context of a buffer allocation scheme, processes, and flowcharts.

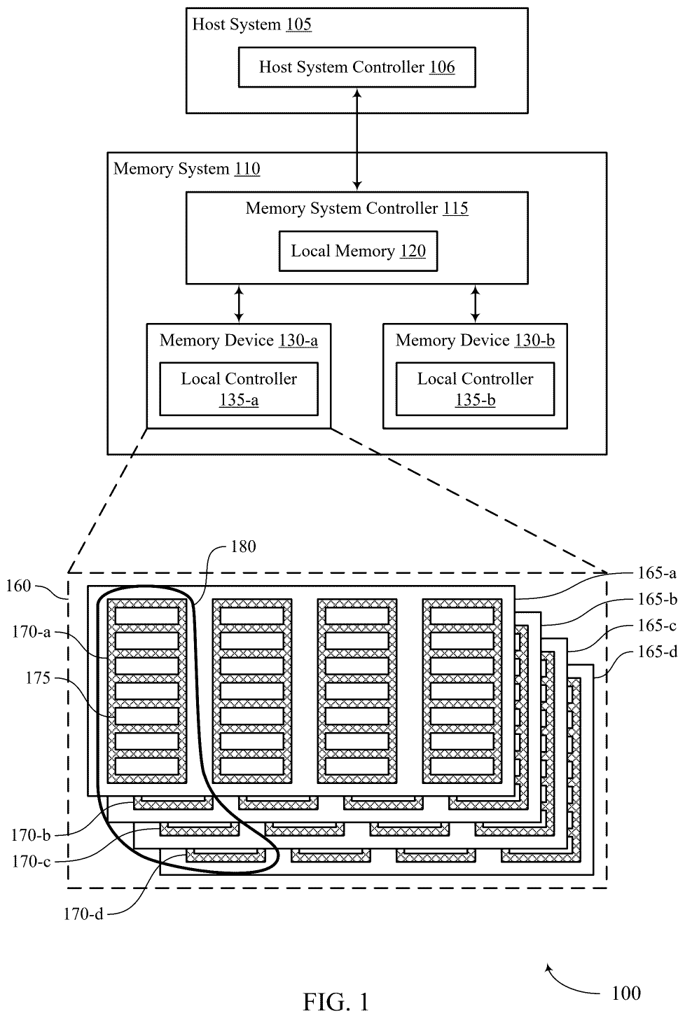

FIG. 1 shows an example of a system 100 that supports configurable L2P table storage extension at a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples of the system 100, a memory system 110 may store L2P tables to volatile memory while executing read commands to support accessing the L2P tables relatively quickly. The memory system 110 may receive multiple read requests, which may result in the memory system 110 loading multiple L2P tables (e.g., if random read data is associated with different regions of memory). In some examples, if a portion of volatile memory allocated for storing loaded L2P tables is full, the memory system 110 may allocate a portion of a write buffer for storing L2P tables. Such schemes may be referred to as L2P extension, and the memory system 110 may trigger the L2P extension when the portion of volatile memory allocated for storing L2P tables is full and the memory system 110 receives a random read request indicating data stored to a region that is associated with an L2P table not present in the volatile memory (e.g., not yet loaded). The memory system 110 may prioritize storing write data in the write buffer and may remove L2P table data from the write buffer if the memory system 110 receives one or more write requests (e.g., flushing L2P data to make room for write data). However, such write requests may include relatively small amounts of data (e.g., small chunk write requests), and removing the L2P table data may result in relatively large portions of the buffer remaining empty after storing the write data (e.g., which may otherwise continue to store L2P table data). Additionally, removing the L2P table data may incur significant latency at the memory system 110 due to the memory system 110 retrieving the L2P table data again after executing the write commands.

In some cases, a memory system 110 may support sharing of host write data and L2P extension data within a write buffer. The memory system 110 may configure a range (e.g., a maximum and a minimum) of amounts of L2P extension data that can be stored to the write buffer when L2P extension is enabled. These quantities may be defined in terms of buffer units (multiples of 1 or more buffer units), where a buffer unit may represent a fixed quantity of storage space within the buffer. If the memory system 110 triggers L2P extension, the memory system 110 may compare a quantity of available buffer units (e.g., buffer units not currently storing data) with an upper bound of the range of buffer units configured for L2P extension. For example, if enough buffer units are available for a full L2P extension, the memory system 110 may allocate the upper bound quantity of buffer units within the write buffer for L2P extension. Alternatively, if there are not enough buffer units available for full L2P extension, the memory system 110 may allocate the currently-available buffer units for L2P extension (e.g., a partial L2P extension). If the memory system 110 allocates a partial L2P extension, the memory system 110 may begin flushing write data stored to the buffer and may allocate newly available buffer units for the L2P extension (e.g., until a full L2P extension is achieved). In some examples, the memory system 110 may dedicate a portion of the write buffer for storing write data, such that small chunk write requests can be serviced while L2P extension is enabled. If the memory system 110 receives a write request including data that has a size greater than the portion dedicated for write data, the memory system 110 may exit the L2P extension and remove L2P data from the buffer. Such techniques may improve memory system 110 performance when receiving relatively large amounts of random read data, which may reduce latency associated with retrieving the random read data while executing small chunk write requests.

The system 100 may include any quantity of non-transitory computer readable media that support configurable L2P table storage extension at a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

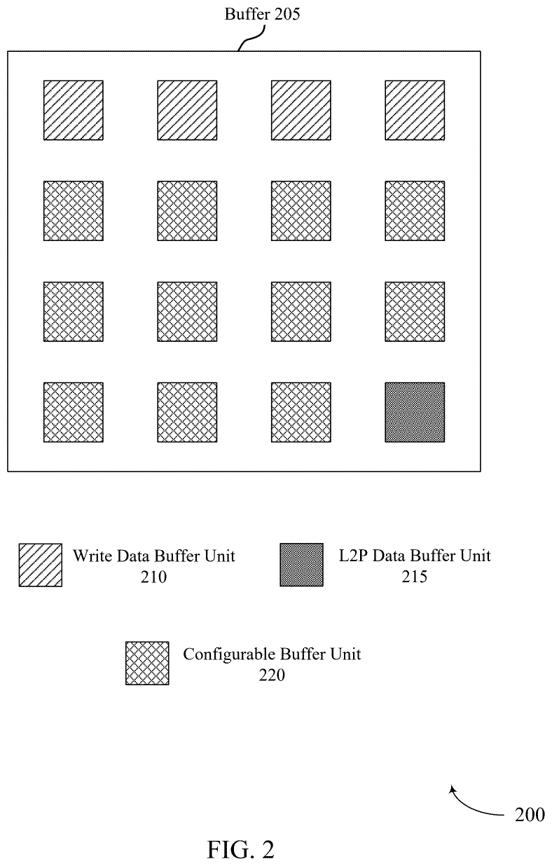

FIG. 2 shows an example of a buffer allocation scheme 200 that supports configurable L2P table storage extension at a memory system in accordance with examples as disclosed herein. The buffer allocation scheme 200 may implement, or be implemented by, one or more aspects of the system 100. For example, the buffer allocation scheme 200 illustrates a buffer 205 at a memory system, which may be an example of corresponding devices and aspects described with reference to FIG. 1. In some cases, the buffer allocation scheme 200 may support the memory system using a write buffer to store L2P tables associated with read data (e.g., L2P extension) when executing random read requests.

The buffer 205 may include multiple buffer units, which may represent a fixed quantity of storage space within the buffer 205 (e.g., 4 KB, or another size granularity). In some cases, the buffer 205 may be a write buffer in volatile memory, and the memory system may store write data to the buffer 205 as part of executing a write operation (e.g., temporarily storing host data before flushing to non-volatile memory of the memory system). If the memory system enables L2P extension (e.g., in response to loading a threshold quantity of L2P tables in another portion of volatile memory), the memory system may partition the buffer units of the buffer 205 to support sharing write data and L2P data concurrently in the buffer 205. For example, the memory system may dedicate a portion of the buffer units as write data buffer units 210 (e.g., buffer units not used to store L2P data).

Additionally, the memory system may configure one or more buffer units to store L2P data. For example, the L2P extension may support a range of quantities of buffer units supported by the memory system for L2P extension, and the memory system may dedicate a lower bound of the range (e.g., a minimum quantity of buffer units) as L2P data buffer units 215 (e.g., 1 buffer unit in the example illustrated by the buffer allocation scheme 200). In some cases, a quantity of buffer units between the lower bound and the upper bound of the range may be configurable buffer units 220, and the memory system may support removing write data from the configurable buffer units 220 and allocating the configurable buffer units 220 as L2P data buffer units 215. For example, if the memory system is unable to allocate the upper bound of the range of buffer units for L2P extension when L2P extension is triggered, the memory system may allocate configurable buffer units 220 that are not used to store write data (e.g., available buffer units not dedicated as write data buffer units 210) as L2P data buffer units 215 and may begin flushing data stored to remaining configurable buffer units 220 until a full L2P extension is achieved.

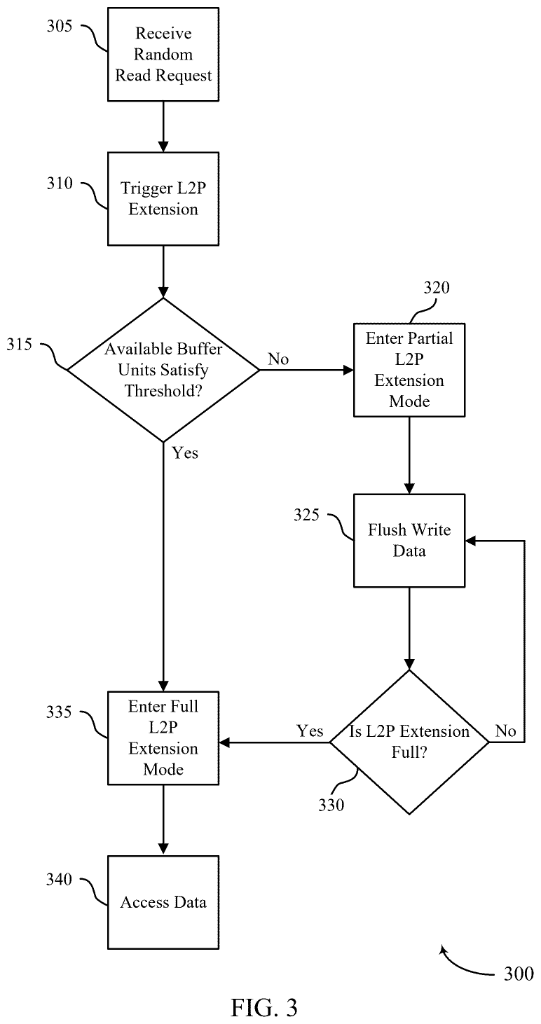

FIG. 3 shows an example of a process 300 that supports configurable L2P table storage extension at a memory system in accordance with examples as disclosed herein. The process 300 may implement, or be implemented by, one or more aspects of the system 100 and the buffer allocation scheme 200. For example, the process 300 may illustrate operations performed and decisions made by a memory system, which may be an example of a memory system 110 described with reference to FIG. 1. The process 300 may support the memory system utilizing a write buffer for L2P extension and sharing host write data and L2P table data in the buffer while L2P extension is enabled, which may be examples of corresponding aspects described with reference to FIGS. 1 and 2.

Aspects of the process 300 may be implemented by one or more controllers, among other components. Additionally, or alternatively, aspects of the process 300 may be implemented as instructions stored in one or more memories (e.g., firmware stored in one or more memories coupled with a host system and/or a memory system). For example, the instructions, when executed by one or more controllers (e.g., a memory system controller 115 of the memory system), may cause the one or more controllers (or a device or a system) to perform the operations of the process 300. Alternative examples of the following may be implemented, where some steps are performed in a different order or not at all. Additionally, some steps may include additional features not mentioned below.

At 305, one or more random read requests may be received. The one or more random read requests may be received by a memory system controller of a memory system. For example, the memory system may receive a read command indicating to retrieve first data stored to the memory system. In some examples, to perform a read operation associated with the read command, the memory system may load an L2P table associated with the first data (e.g., according to logical addresses of the data indicated by the read command). The L2P table may be associated with a region of memory within the memory system, which may be an example of a logical partition of a memory array and may include a set of physical addresses. In some cases, the memory system may allocate a portion of volatile memory (e.g., RAM or SRAM) for storing L2P tables loaded in response to read requests. However, if the memory system receives a relatively large quantity of random read commands (where read data may be associated with various memory regions) prior to receiving the read command, the portion of volatile memory may be insufficient to store the L2P table associated with the first data. In such examples, the memory system may proceed to step 310 of the process 300.

At 310, L2P extension may be triggered. The L2P extension may be triggered by the memory system controller of the memory system. In some cases, the L2P extension may be an example of a mode of the memory system where the memory system may allocate a portion of a write buffer (e.g., configured to temporarily store write data before flushing to non-volatile memory) for storing L2P table data. For example, the L2P extension may be enabled when the memory system loads an L2P table and the portion of volatile memory allocated for storing L2P tables is full (e.g., the write buffer may serve as overflow L2P table storage). In some cases, the L2P extension may support sharing of host write data and L2P table data within the write buffer (e.g., the write buffer may concurrently store write data and L2P table data). The write buffer may be located in volatile memory of the memory system controller.

In some examples, based on triggering the L2P extension mode, the memory system may partition the write buffer such that a first portion of the write buffer is dedicated for storing write data and a second portion of the write buffer may be used for storing L2P table data. Such portions may be defined in terms of buffer units, which may be an example of a fixed quantity of storage space within the buffer. For example, a first set of one or more buffer units within the buffer may store data associated with write commands received at the memory system, and the L2P extension may enable the memory system to allocate a second set of one or more buffer units to store one or more L2P tables. The L2P extension may support, for storing L2P table data within the write buffer, a range of quantities of buffer units including an upper bound quantity of buffer units (e.g., a maximum quantity of buffer units that may be used for L2P table data) and a lower bound quantity of buffer units (e.g., a minimum quantity of buffer units that may be used for L2P table data), as described with reference to FIG. 2. In some examples, allocating the upper bound quantity of buffer units for L2P table storage may be referred to as a full L2P extension, while allocating less than the upper bound quantity of buffer units for L2P table storage may be referred to as a partial L2P extension.

At 315, whether a quantity of available buffer units within the write buffer satisfies a threshold value may be determined. The memory system controller may scan the write buffer to determine the quantity of available buffer units and may compare the quantity of available buffer units to the threshold value. An available buffer unit may refer to a buffer unit that does not store data (e.g., is empty) and the threshold value may correspond to the upper bound quantity of buffer units supported by the L2P extension mode. For example, if the memory system determines that the quantity of available buffer units does not satisfy (e.g., is less than) the threshold value, the memory system may determine that a partial L2P extension can be achieved and may proceed to step 320 of the process 300. Alternatively, if the memory system determines that the quantity of available buffer units satisfies (e.g., is greater than or equal to) the threshold value, the memory system may determine that a full L2P extension can be achieved and may proceed to step 335 of the process 300.

At 320, a partial L2P extension mode may be entered. For example, the memory system controller may determine to enter the partial L2P extension mode based on determining that the quantity of available buffer units fails to satisfy the threshold value. In some cases, the partial L2P extension may include the memory system allocating a first quantity of buffer units to store one or more L2P tables, where the first quantity of buffer units may be less than the upper bound quantity of buffer units within the write buffer supported by the memory system for storing L2P tables. For example, the second set of one or more buffer units may include the first quantity of buffer units corresponding to the available buffer units that are not dedicated for storing write data (e.g., one or more available configurable buffer units 220 described with reference to FIG. 2). In some examples, the memory system may initiate an operation associated with allocating the second set of one or more buffer units to store L2P tables, which may include scheduling an L2P extension task associated with allocating additional buffer units for L2P extension until the memory system achieves a full L2P extension. For example, the memory system may schedule a flush of write data stored to the write buffer based on entering the partial L2P extension mode.

At 325, write data may be flushed. For example, the memory system controller may flush at least a portion of write data stored to the buffer. In some examples, the memory system may transfer write data (which may be referred to as second data) from a buffer unit within the first set of one or more buffer units that store write data (e.g., a configurable buffer unit 220 described with reference to FIG. 2 that stores write data when L2P extension is triggered). The memory system may transfer the data from the buffer unit to a memory array of the memory system (e.g., non-volatile memory) and may add the buffer unit to the second set of one or more buffer units allocated to store L2P tables. For example, after removing the write data from the buffer unit, the second set of one or more buffer units may include a second quantity that is greater than the first quantity (e.g., iteratively increasing the buffer units allocated for L2P table storage).

At 330, whether the L2P extension is full may be determined. The memory system controller may identify, after flushing write data from a buffer unit and adding the buffer unit to the second set of buffer units allocated for L2P table storage, if the quantity of the second set of buffer units satisfies the threshold value. For example, the memory system may determine whether the second quantity of the second set of buffer units (e.g., including the newly-available buffer unit) corresponds to the upper bound quantity of buffer units supported by the L2P extension. If the memory system identifies that the second quantity of buffer units corresponds to the upper bound quantity of buffer units (e.g., full L2P extension is achieved), the memory system may terminate the operation associated with allocating the second set of buffer units and may proceed to step 335 of the process 300. Alternatively, if the memory system identifies that the second quantity of buffer units is less than the upper bound quantity of buffer units (e.g., full L2P extension is not yet achieved), the memory system may return to step 325 and may continue to flush write data from buffer units that may be used for L2P extension (e.g., configurable buffer units 220 described with reference to FIG. 2 that store write data) until a full L2P extension is achieved.

At 335, a full L2P extension mode may be entered. For example, the memory system controller may determine to enter the full L2P extension mode based on the quantity of buffer units allocated for L2P table storage corresponding to the upper bound quantity of buffer units supported by the memory system for storing L2P tables. In some cases, the memory system may enter the full L2P extension mode based on determining the buffer includes the threshold quantity of available buffer units when L2P extension is triggered (e.g., at 315) or the memory system may enter the full L2P extension mode based on iteratively flushing write data from buffer units and allocating the buffer units for L2P table storage until the quantity of buffer units allocated for L2P table storage is determined to satisfy the threshold value (e.g., at 330). The full L2P extension mode may support the memory system storing L2P tables, such as at least a portion of the L2P table associated with the first data, using the upper bound quantity of buffer units. In some examples, entering the full L2P extension mode may terminate a task associated with L2P extension (e.g., a firmware entry may indicate a full extension status).

At 340, data may be accessed. For example, the memory system controller may access (e.g., read, retrieve) the first data indicated by the read command based on storing the L2P table associated with the first data (e.g., in accordance with the full L2P extension mode). In some examples, the memory system controller may retrieve additional data associated with other L2P tables stored in accordance with the full L2P extension mode. The full L2P extension mode may enable the memory system controller to access L2P tables stored to a write buffer using an upper bound quantity of buffer units to retrieve data from various regions of the memory system.

Such techniques may improve performance of the memory system in response to receiving relatively large quantities of random read requests, which may reduce latency associated with executing access commands.

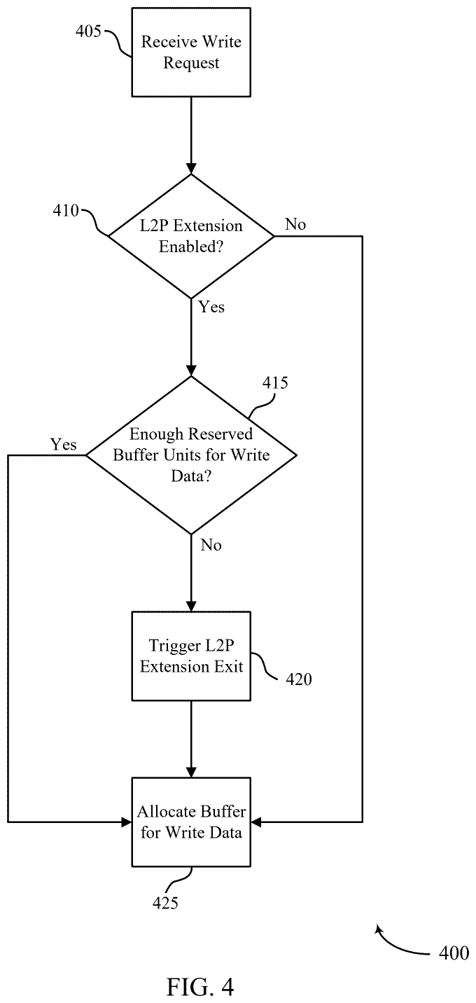

FIG. 4 shows an example of a process 400 that supports configurable L2P table storage extension at a memory system in accordance with examples as disclosed herein. The process 400 may implement, or be implemented by, one or more aspects of the system 100, the buffer allocation scheme 200, and the process 300. For example, the process 400 may illustrate operations performed and decisions made by a memory system, which may be an example of corresponding devices described with reference to FIGS. 1 through 3. In some examples, the process 400 may support the memory system storing write data to a write buffer that shares write data and L2P table data in accordance with an L2P extension mode enabled at the memory system, which may be examples of corresponding aspects described with reference to FIGS. 2 and 3.

Aspects of the process 400 may be implemented by one or more controllers, among other components. Additionally, or alternatively, aspects of the process 400 may be implemented as instructions stored in one or more memories (e.g., firmware stored in one or more memories coupled with a host system and/or a memory system). For example, the instructions, when executed by one or more controllers (e.g., a memory system controller 115 of the memory system), may cause the one or more controllers (or a device or a system) to perform the operations of the process 400. Alternative examples of the following may be implemented, where some steps are performed in a different order or not at all. Additionally, some steps may include additional features not mentioned below.

At 405, a write request may be received. The write request may be received by a memory system controller of a memory system. For example, the memory system may receive a write command indicating data (which may be referred to as third data) to be stored to one or more memory arrays of the memory system.

At 410, whether L2P extension is enabled may be determined. The memory system controller may determine whether the L2P extension mode is enabled at the memory system. For example, the memory system controller may determine whether a write buffer at the memory system controller concurrently stores write data and L2P table data (e.g., whether L2P extension has been triggered at step 310 with reference to the process 300). If the memory system determines that L2P extension is enabled, the memory system may proceed to step 415 of the process 400. Alternatively, if the memory system determines that L2P extension is not enabled, the memory system may proceed to step 425 of the process 400.

At 415, whether enough reserved buffer units are available for the write data may be determined. For example, the memory system controller may determine whether a quantity of buffer units (which may be referred to as a third quantity) dedicated for storing write data within the write buffer is greater than or equal to a quantity of buffer units (which may be referred to as a fourth quantity) associated with a size of the data indicated in the write command. If the memory system determines that the third quantity of buffer units is less than the fourth quantity of buffer units (e.g., the size of the data indicated in the write command exceeds the portion of the write buffer dedicated for storing write data), the memory system may proceed to step 420 of the process 400. Alternatively, if the memory system determines that the third quantity of buffer units is greater than or equal to the fourth quantity of buffer units (e.g., the size of the data can be supported by the portion of the write buffer dedicated for storing write data, such as a small chunk write command), the memory system may proceed to step 425 of the process 400.

At 420, L2P extension exit may be triggered. For example, the memory system controller may determine to exit the L2P extension mode based on determining that the buffer units dedicated for storing write data is less than the size of the data indicated in the write command. In some cases, triggering the L2P extension exit may include the memory system terminating an operation associated with allocating buffer units of the write buffer for storing one or more L2P tables. Additionally, or alternatively, the memory system may transfer one or more L2P tables stored to the write buffer to one or more memory arrays of the memory system based on triggering the L2P extension exit. In some cases, triggering the L2P extension exit may be due to the memory system prioritizing storing write data over storing L2P table data in the write buffer.

At 425, the buffer may be allocated to store write data. For example, the memory system controller may allocate one or more buffer units of the write buffer to store the data indicated in the write request. In some examples, the memory system may store the data to at least the one or more buffer units dedicated for storing write data (e.g., write data buffer units 210 described with reference to FIG. 2). For example, if the data is indicated in a small chunk write request, the one or more buffer units dedicated for storing write data may be suitable to store the data. Alternatively, if the memory system determined to exit the L2P extension mode, the memory system may store the data to additional buffer units beyond the one or more buffer units dedicated for storing write data based on transferring the L2P table data from the write buffer.

Such techniques may improve performance of the memory system in response to receiving write requests while storing L2P table data in a write buffer, which may reduce latency associated with executing access commands.

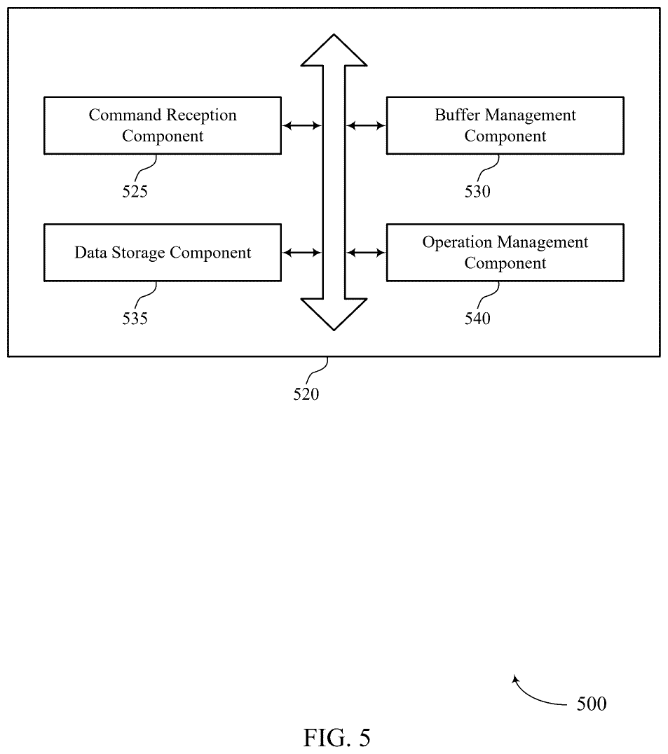

FIG. 5 shows a block diagram 500 of a memory system 520 that supports configurable L2P table storage extension at a memory system in accordance with examples as disclosed herein. The memory system 520 may be an example of aspects of a memory system as described with reference to FIGS. 1 through 4. The memory system 520, or various components thereof, may be an example of means for performing various aspects of configurable L2P table storage extension at a memory system as described herein. For example, the memory system 520 may include a command reception component 525, a buffer management component 530, a data storage component 535, an operation management component 540, or any combination thereof. Each of these components, or components of subcomponents thereof (e.g., one or more processors, one or more memories), may communicate, directly or indirectly, with one another (e.g., via one or more buses).

The command reception component 525 may be configured as or otherwise support a means for receiving a read command for first data stored to the memory system. The buffer management component 530 may be configured as or otherwise support a means for determining, in response to receiving the read command, whether a quantity of available buffer units within a buffer of the memory system satisfies a threshold value, where a buffer unit includes a fixed quantity of storage space within the buffer, and where at least a portion of a first set of one or more buffer units within the buffer store data associated with write commands received at the memory system. In some examples, the buffer management component 530 may be configured as or otherwise support a means for allocating, within the buffer, a second set of one or more buffer units to store one or more L2P tables, where the second set of one or more buffer units includes a first quantity of one or more buffer units that is in accordance with whether the quantity of available buffer units satisfies the threshold value. The data storage component 535 may be configured as or otherwise support a means for storing at least a portion of a L2P table associated with the first data in a first buffer unit within the buffer, where the first buffer unit is included in the second set of one or more buffer units.

In some examples, to support determining whether the quantity of available buffer units within the buffer satisfies the threshold value, the buffer management component 530 may be configured as or otherwise support a means for determining that the quantity of available buffer units within the buffer satisfies the threshold value, where, in accordance with the quantity of available buffer units satisfying the threshold value, the first quantity of one or more buffer units allocated to the second set corresponds to an upper bound of a range of quantities of buffer units supported by the memory system for storing the one or more L2P tables.

In some examples, to support determining whether the quantity of available buffer units within the buffer satisfies the threshold value, the buffer management component 530 may be configured as or otherwise support a means for determining that the quantity of available buffer units within the buffer fails to satisfy the threshold value, where, in accordance with the quantity of available buffer units failing to satisfy the threshold value, the first quantity of one or more buffer units allocated to the second set is less than an upper bound of a range of quantities of buffer units supported by the memory system for storing the one or more L2P tables.

In some examples, the data storage component 535 may be configured as or otherwise support a means for transferring, in accordance with the quantity of available buffer units failing to satisfy the threshold value, at least a portion of second data from a second buffer unit within the first set of one or more buffer units to a memory array of the memory system. In some examples, the buffer management component 530 may be configured as or otherwise support a means for adding, in accordance with transferring at least the portion of the second data from the second buffer unit, the second buffer unit to the second set of one or more buffer units allocated to store the one or more L2P tables, where the second set of one or more buffer units includes a second quantity of one or more buffer units after adding the second buffer unit.

In some examples, the buffer management component 530 may be configured as or otherwise support a means for determining that the second quantity of one or more buffer units corresponds to the upper bound of the range of quantities of buffer units. In some examples, the operation management component 540 may be configured as or otherwise support a means for terminating, in accordance with the second quantity of one or more buffer units corresponding to the upper bound of the range of quantities of buffer units, an operation associated with allocating the second set of one or more buffer units to store the one or more L2P tables.

In some examples, the command reception component 525 may be configured as or otherwise support a means for receiving a write command indicating to store third data to the memory system. In some examples, the operation management component 540 may be configured as or otherwise support a means for determining, in accordance with whether a third quantity of the first set of one or more buffer units is greater than or equal to a fourth quantity of buffer units associated with a size of the third data, whether to terminate an operation associated with allocating the second set of one or more buffer units to store the one or more L2P tables. In some examples, the data storage component 535 may be configured as or otherwise support a means for storing the third data to the buffer.

In some examples, to support determining whether to terminate the operation associated with allocating the second set of one or more buffer units to store the one or more L2P tables, the operation management component 540 may be configured as or otherwise support a means for determining to terminate the operation in accordance with the third quantity of the first set of one or more buffer units being less than the fourth quantity of buffer units. In some examples, to support determining whether to terminate the operation associated with allocating the second set of one or more buffer units to store the one or more L2P tables, the data storage component 535 may be configured as or otherwise support a means for transferring the one or more L2P tables from the second set of one or more buffer units to one or more memory arrays of the memory system, where storing the third data to the buffer occurs after transferring the one or more L2P tables from the second set of one or more buffer units to the one or more memory arrays.

In some examples, the operation management component 540 may be configured as or otherwise support a means for enabling, in response to receiving the read command, a L2P extension mode of the memory system, where, in accordance with the L2P extension mode being enabled, the buffer concurrently stores the data associated with the write commands within the first set of one or more buffer units and stores at least the portion of the L2P table within the first buffer unit that is included in the second set of one or more buffer units.

In some examples, the read command includes a random read command.

In some examples, the buffer is within random access memory of a controller within the memory system.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

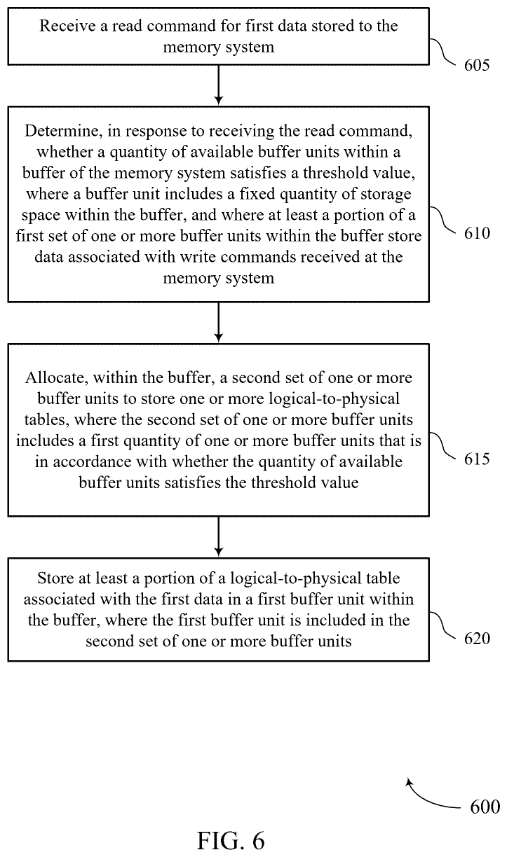

FIG. 6 shows a flowchart illustrating a method 600 that supports configurable L2P table storage extension at a memory system in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving a read command for first data stored to the memory system. In some examples, aspects of the operations of 605 may be performed by a command reception component 525 as described with reference to FIG. 5.

At 610, the method may include determining, in response to receiving the read command, whether a quantity of available buffer units within a buffer of the memory system satisfies a threshold value, where a buffer unit includes a fixed quantity of storage space within the buffer, and where at least a portion of a first set of one or more buffer units within the buffer store data associated with write commands received at the memory system. In some examples, aspects of the operations of 610 may be performed by a buffer management component 530 as described with reference to FIG. 5.

At 615, the method may include allocating, within the buffer, a second set of one or more buffer units to store one or more L2P tables, where the second set of one or more buffer units includes a first quantity of one or more buffer units that is in accordance with whether the quantity of available buffer units satisfies the threshold value. In some examples, aspects of the operations of 615 may be performed by a buffer management component 530 as described with reference to FIG. 5.

At 620, the method may include storing at least a portion of a L2P table associated with the first data in a first buffer unit within the buffer, where the first buffer unit is included in the second set of one or more buffer units. In some examples, aspects of the operations of 620 may be performed by a data storage component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a read command for first data stored to the memory system; determining, in response to receiving the read command, whether a quantity of available buffer units within a buffer of the memory system satisfies a threshold value, where a buffer unit includes a fixed quantity of storage space within the buffer, and where at least a portion of a first set of one or more buffer units within the buffer store data associated with write commands received at the memory system; allocating, within the buffer, a second set of one or more buffer units to store one or more L2P tables, where the second set of one or more buffer units includes a first quantity of one or more buffer units that is in accordance with whether the quantity of available buffer units satisfies the threshold value; and storing at least a portion of a L2P table associated with the first data in a first buffer unit within the buffer, where the first buffer unit is included in the second set of one or more buffer units.

Aspect 2: The method, apparatus, or non-transitory computer-readable medium of aspect 1, where operations, features, circuitry, logic, means, or instructions, or any combination thereof for determining whether the quantity of available buffer units within the buffer satisfies the threshold value includes operations, features, circuitry, logic, means, or instructions, or any combination thereof for determining that the quantity of available buffer units within the buffer satisfies the threshold value, where, in accordance with the quantity of available buffer units satisfying the threshold value, the first quantity of one or more buffer units allocated to the second set corresponds to an upper bound of a range of quantities of buffer units supported by the memory system for storing the one or more L2P tables.

Aspect 3: The method, apparatus, or non-transitory computer-readable medium of any of aspects 1 through 2, where operations, features, circuitry, logic, means, or instructions, or any combination thereof for determining whether the quantity of available buffer units within the buffer satisfies the threshold value includes operations, features, circuitry, logic, means, or instructions, or any combination thereof for determining that the quantity of available buffer units within the buffer fails to satisfy the threshold value, where, in accordance with the quantity of available buffer units failing to satisfy the threshold value, the first quantity of one or more buffer units allocated to the second set is less than an upper bound of a range of quantities of buffer units supported by the memory system for storing the one or more L2P tables.

Aspect 4: The method, apparatus, or non-transitory computer-readable medium of aspect 3, further including operations, features, circuitry, logic, means, or instructions, or any combination thereof for transferring, in accordance with the quantity of available buffer units failing to satisfy the threshold value, at least a portion of second data from a second buffer unit within the first set of one or more buffer units to a memory array of the memory system and adding, in accordance with transferring at least the portion of the second data from the second buffer unit, the second buffer unit to the second set of one or more buffer units allocated to store the one or more L2P tables, where the second set of one or more buffer units includes a second quantity of one or more buffer units after adding the second buffer unit.

Aspect 5: The method, apparatus, or non-transitory computer-readable medium of aspect 4, further including operations, features, circuitry, logic, means, or instructions, or any combination thereof for determining that the second quantity of one or more buffer units corresponds to the upper bound of the range of quantities of buffer units and terminating, in accordance with the second quantity of one or more buffer units corresponding to the upper bound of the range of quantities of buffer units, an operation associated with allocating the second set of one or more buffer units to store the one or more L2P tables.

Aspect 6: The method, apparatus, or non-transitory computer-readable medium of any of aspects 1 through 5, further including operations, features, circuitry, logic, means, or instructions, or any combination thereof for receiving a write command indicating to store third data to the memory system; determining, in accordance with whether a third quantity of the first set of one or more buffer units is greater than or equal to a fourth quantity of buffer units associated with a size of the third data, whether to terminate an operation associated with allocating the second set of one or more buffer units to store the one or more L2P tables; and storing the third data to the buffer.

Aspect 7: The method, apparatus, or non-transitory computer-readable medium of aspect 6, where operations, features, circuitry, logic, means, or instructions, or any combination thereof for determining whether to terminate the operation associated with allocating the second set of one or more buffer units to store the one or more L2P tables includes operations, features, circuitry, logic, means, or instructions, or any combination thereof for determining to terminate the operation in accordance with the third quantity of the first set of one or more buffer units being less than the fourth quantity of buffer units, where terminating the operation includes and transferring the one or more L2P tables from the second set of one or more buffer units to one or more memory arrays of the memory system, where storing the third data to the buffer occurs after transferring the one or more L2P tables from the second set of one or more buffer units to the one or more memory arrays.

Aspect 8: The method, apparatus, or non-transitory computer-readable medium of any of aspects 1 through 7, further including operations, features, circuitry, logic, means, or instructions, or any combination thereof for enabling, in response to receiving the read command, a L2P extension mode of the memory system, where, in accordance with the L2P extension mode being enabled, the buffer concurrently stores the data associated with the write commands within the first set of one or more buffer units and stores at least the portion of the L2P table within the first buffer unit that is included in the second set of one or more buffer units.

Aspect 9: The method, apparatus, or non-transitory computer-readable medium of any of aspects 1 through 8, where the read command includes a random read command.

Aspect 10: The method, apparatus, or non-transitory computer-readable medium of any of aspects 1 through 9, where the buffer is within random access memory of a controller within the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a read command for first data stored to the memory system;
determine, in response to receiving the read command, whether a quantity of available buffer units within a buffer of the memory system satisfies a threshold value, wherein a buffer unit comprises a fixed quantity of storage space within the buffer, and wherein at least a portion of a first set of one or more buffer units within the buffer are allocated to store data associated with write commands received at the memory system;
allocate, within the buffer, a second set of one or more buffer units to store one or more logical-to-physical tables, wherein the second set of one or more buffer units comprises a first quantity of one or more buffer units that is in accordance with whether the quantity of available buffer units satisfies the threshold value; and
store at least a portion of a logical-to-physical table associated with the first data in a first buffer unit within the buffer, wherein the first buffer unit is included in the second set of one or more buffer units.

2. The memory system of claim 1, wherein, to determine whether the quantity of available buffer units within the buffer satisfies the threshold value, the processing circuitry is configured to cause the memory system to:
determine that the quantity of available buffer units within the buffer satisfies the threshold value, wherein, in accordance with the quantity of available buffer units satisfying the threshold value, the first quantity of one or more buffer units allocated to the second set corresponds to an upper bound of a range of quantities of buffer units supported by the memory system for storing the one or more logical-to-physical tables.

3. The memory system of claim 1, wherein, to determine whether the quantity of available buffer units within the buffer satisfies the threshold value, the processing circuitry is configured to cause the memory system to:
determine that the quantity of available buffer units within the buffer fails to satisfy the threshold value, wherein, in accordance with the quantity of available buffer units failing to satisfy the threshold value, the first quantity of one or more buffer units allocated to the second set is less than an upper bound of a range of quantities of buffer units supported by the memory system for storing the one or more logical-to-physical tables.

4. The memory system of claim 3, wherein the processing circuitry is further configured to cause the memory system to:
transfer, in accordance with the quantity of available buffer units failing to satisfy the threshold value, at least a portion of second data from a second buffer unit within the first set of one or more buffer units to a memory array of the memory system; and
add, in accordance with transferring at least the portion of the second data from the second buffer unit, the second buffer unit to the second set of one or more buffer units allocated to store the one or more logical-to-physical tables, wherein the second set of one or more buffer units comprises a second quantity of one or more buffer units after adding the second buffer unit.

5. The memory system of claim 4, wherein the processing circuitry is further configured to cause the memory system to:
determine that the second quantity of one or more buffer units corresponds to the upper bound of the range of quantities of buffer units; and
terminate, in accordance with the second quantity of one or more buffer units corresponding to the upper bound of the range of quantities of buffer units, an operation associated with allocating the second set of one or more buffer units to store the one or more logical-to-physical tables.

6. The memory system of claim 1, wherein the processing circuitry is further configured to cause the memory system to:
receive a write command indicating to store third data to the memory system;
determine, in accordance with whether a third quantity of the first set of one or more buffer units is greater than or equal to a fourth quantity of buffer units associated with a size of the third data, whether to terminate an operation associated with allocating the second set of one or more buffer units to store the one or more logical-to-physical tables; and
store the third data to the buffer.

7. The memory system of claim 6, wherein, to determine whether to terminate the operation associated with allocating the second set of one or more buffer units to store the one or more logical-to-physical tables, the processing circuitry is configured to cause the memory system to:
determine to terminate the operation in accordance with the third quantity of the first set of one or more buffer units being less than the fourth quantity of buffer units, wherein, to terminate the operation, the processing circuitry is configured to cause the memory system to:
transfer the one or more logical-to-physical tables from the second set of one or more buffer units to one or more memory arrays of the memory system, wherein the processing circuitry is configured to cause the memory system to store the third data to the buffer after transferring the one or more logical-to-physical tables from the second set of one or more buffer units to the one or more memory arrays.

8. The memory system of claim 1, wherein the processing circuitry is further configured to cause the memory system to:
enable, in response to receiving the read command, a logical-to-physical extension mode of the memory system, wherein, in accordance with the logical-to-physical extension mode being enabled, the processing circuitry is configured to cause the buffer to concurrently store the data associated with the write commands within the first set of one or more buffer units and store at least the portion of the logical-to-physical table within the first buffer unit that is included in the second set of one or more buffer units.

9. The memory system of claim 1, wherein the read command comprises a random read command.

10. The memory system of claim 1, wherein the buffer is within random access memory of a controller within the memory system.

11. A non-transitory computer-readable medium storing code comprising instructions which, when executed by one or more processors of a memory system, cause the memory system to:
receive a read command for first data stored to the memory system;
determine, in response to receiving the read command, whether a quantity of available buffer units within a buffer of the memory system satisfies a threshold value, wherein a buffer unit comprises a fixed quantity of storage space within the buffer, and wherein at least a portion of a first set of one or more buffer units within the buffer are allocated to store data associated with write commands received at the memory system;
allocate, within the buffer, a second set of one or more buffer units to store one or more logical-to-physical tables, wherein the second set of one or more buffer units comprises a first quantity of one or more buffer units that is in accordance with whether the quantity of available buffer units satisfies the threshold value; and
store at least a portion of a logical-to-physical table associated with the first data in a first buffer unit within the buffer, wherein the first buffer unit is included in the second set of one or more buffer units.

12. The non-transitory computer-readable medium of claim 11, wherein, to determine whether the quantity of available buffer units within the buffer satisfies the threshold value, the instructions, when executed by the one or more processors of the memory system, cause the memory system to:
determine that the quantity of available buffer units within the buffer satisfies the threshold value, wherein, in accordance with the quantity of available buffer units satisfying the threshold value, the first quantity of one or more buffer units allocated to the second set corresponds to an upper bound of a range of quantities of buffer units supported by the memory system for storing the one or more logical-to-physical tables.

13. The non-transitory computer-readable medium of claim 11, wherein, to determine whether the quantity of available buffer units within the buffer satisfies the threshold value, the instructions, when executed by the one or more processors of the memory system, cause the memory system to:
determine that the quantity of available buffer units within the buffer fails to satisfy the threshold value, wherein, in accordance with the quantity of available buffer units failing to satisfy the threshold value, the first quantity of one or more buffer units allocated to the second set is less than an upper bound of a range of quantities of buffer units supported by the memory system for storing the one or more logical-to-physical tables.

14. The non-transitory computer-readable medium of claim 13, wherein the instructions, when executed by the one or more processors of the memory system, further cause the memory system to:
transfer, in accordance with the quantity of available buffer units failing to satisfy the threshold value, at least a portion of second data from a second buffer unit within the first set of one or more buffer units to a memory array of the memory system; and
add, in accordance with transferring at least the portion of the second data from the second buffer unit, the second buffer unit to the second set of one or more buffer units allocated to store the one or more logical-to-physical tables, wherein the second set of one or more buffer units comprises a second quantity of one or more buffer units after adding the second buffer unit.

15. The non-transitory computer-readable medium of claim 14, wherein the instructions, when executed by the one or more processors of the memory system, further cause the memory system to:
determine that the second quantity of one or more buffer units corresponds to the upper bound of the range of quantities of buffer units; and
terminate, in accordance with the second quantity of one or more buffer units corresponding to the upper bound of the range of quantities of buffer units, an operation associated with allocating the second set of one or more buffer units to store the one or more logical-to-physical tables.

16. The non-transitory computer-readable medium of claim 11, wherein the instructions, when executed by the one or more processors of the memory system, further cause the memory system to:
receive a write command indicating to store third data to the memory system;
determine, in accordance with whether a third quantity of the first set of one or more buffer units is greater than or equal to a fourth quantity of buffer units associated with a size of the third data, whether to terminate an operation associated with allocating the second set of one or more buffer units to store the one or more logical-to-physical tables; and
store the third data to the buffer.

17. The non-transitory computer-readable medium of claim 16, wherein, to determine whether to terminate the operation associated with allocating the second set of one or more buffer units to store the one or more logical-to-physical tables, the instructions, when executed by the one or more processors of the memory system, cause the memory system to:
determine to terminate the operation in accordance with the third quantity of the first set of one or more buffer units being less than the fourth quantity of buffer units, wherein, to terminate the operation, the instructions, when executed by the one or more processors of the memory system, cause the memory system to:
transfer the one or more logical-to-physical tables from the second set of one or more buffer units to one or more memory arrays of the memory system, wherein the instructions, when executed by the one or more processors of the memory system, cause the memory system to store the third data to the buffer after transferring the one or more logical-to-physical tables from the second set of one or more buffer units to the one or more memory arrays.

18. The non-transitory computer-readable medium of claim 11, wherein the instructions, when executed by the one or more processors of the memory system, further cause the memory system to:
enable, in response to receiving the read command, a logical-to-physical extension mode of the memory system, wherein, in accordance with the logical-to-physical extension mode being enabled, the instructions, when executed by the one or more processors of the memory system, cause the buffer to concurrently store the data associated with the write commands within the first set of one or more buffer units and store at least the portion of the logical-to-physical table within the first buffer unit that is included in the second set of one or more buffer units.

19. The non-transitory computer-readable medium of claim 11, wherein the read command comprises a random read command.

20. The non-transitory computer-readable medium of claim 11, wherein the buffer is within random access memory of a controller within the memory system.

21. A method by a memory system, comprising:
receiving a read command for first data stored to the memory system;
determining, in response to receiving the read command, whether a quantity of available buffer units within a buffer of the memory system satisfies a threshold value, wherein a buffer unit comprises a fixed quantity of storage space within the buffer, and wherein at least a portion of a first set of one or more buffer units within the buffer store data associated with write commands received at the memory system;
allocating, within the buffer, a second set of one or more buffer units to store one or more logical-to-physical tables, wherein the second set of one or more buffer units comprises a first quantity of one or more buffer units that is in accordance with whether the quantity of available buffer units satisfies the threshold value; and
storing at least a portion of a logical-to-physical table associated with the first data in a first buffer unit within the buffer, wherein the first buffer unit is included in the second set of one or more buffer units.

22. The method of claim 21, wherein determining whether the quantity of available buffer units within the buffer satisfies the threshold value comprises:
determining that the quantity of available buffer units within the buffer satisfies the threshold value, wherein, in accordance with the quantity of available buffer units satisfying the threshold value, the first quantity of one or more buffer units allocated to the second set corresponds to an upper bound of a range of quantities of buffer units supported by the memory system for storing the one or more logical-to-physical tables.

23. The method of claim 21, wherein determining whether the quantity of available buffer units within the buffer satisfies the threshold value comprises:
determining that the quantity of available buffer units within the buffer fails to satisfy the threshold value, wherein, in accordance with the quantity of available buffer units failing to satisfy the threshold value, the first quantity of one or more buffer units allocated to the second set is less than an upper bound of a range of quantities of buffer units supported by the memory system for storing the one or more logical-to-physical tables.

24. The method of claim 23, further comprising:
transferring, in accordance with the quantity of available buffer units failing to satisfy the threshold value, at least a portion of second data from a second buffer unit within the first set of one or more buffer units to a memory array of the memory system; and
adding, in accordance with transferring at least the portion of the second data from the second buffer unit, the second buffer unit to the second set of one or more buffer units allocated to store the one or more logical-to-physical tables, wherein the second set of one or more buffer units comprises a second quantity of one or more buffer units after adding the second buffer unit.

25. The method of claim 24, further comprising:
determining that the second quantity of one or more buffer units corresponds to the upper bound of the range of quantities of buffer units; and
terminating, in accordance with the second quantity of one or more buffer units corresponding to the upper bound of the range of quantities of buffer units, an operation associated with allocating the second set of one or more buffer units to store the one or more logical-to-physical tables.
